(19) United States
(12) Patent Application Publication
(10) Pub. No.: US 2022/0064469 A1
(43) Pub. Date: Mar. 3, 2022

(54) WRITING AND/OR DRAWING SYSTEM COMPRISING PH SENSITIVE DYE AND METHOD THEREOF

(71) Applicant: Sanko Tekstil Isletmeleri San. Ve Tic. A.S., Inegol - BURSA (TR)

(72) Inventors: Gokhan KAPLAN, Inegol - BURSA (TR); Gozde OKTEM, Inegol - BURSA (TR); Ertug ERKUS, Inegol - BURSA (TR)

(21) Appl. No.: 17/418,927

(22) PCT Filed: Jan. 3, 2020
(86) PCT No.: PCT/EP2020/050079

§ 371 Date: Jun. 28, 2021

(30) Foreign Application Priority Data
Jan. 4, 2019 (EP) 19150403.4

(51) Int. Cl. C09D 11/50; D06P 5/15; D06P 1/00; C09D 11/17; B44D 3/18; B41M 3/00

(52) U.S. Cl. CPC C09D 11/50; D06P 5/151; B41M 3/001; C09D 11/17; B44D 3/185; D06P 1/00

(57) ABSTRACT

The invention refers to a writing and/or drawing system comprising a pH sensitive dye and a writing material having a pH configured to provide a change in the colour of said dye on said surface of the support, as well as to a method to write and/or draw on the system with the writing material.

### FIELD OF THE INVENTION

The present invention concerns a type of board treated in a way as to give it colour-changing properties. More specifically, said board can comprise a fabric, including any cellulosic material such as a canvas. The material is dyed with pH sensitive molecules. The molecule(s) used for dyeing the board is/are pH sensitive, and can change their colour based on pH: therefore, the coloured material can change its colour depending on the pH. More specifically, the colour of the material can then be changed by means of varying its pH through application of acid or basic substances and solutions.

These changes in colour are not permanent and persist as long as the pH remains unchanged. The colour can be reverted by returning the pH of the board to its original value. This colour-changing process can be repeated multiple times.

### BACKGROUND OF THE INVENTION

Several pH sensitive chemicals are known in literature. They have been used mainly as indicators or sensors. It is also known that such chemicals can be applied to various materials such as textiles, plastic, and paper thus giving it the ability to change colour. Common applications of this technology are commonly found in children's books with so-called “magic markers”, where the user can apply a specific chemical solution to the pages through a specific marker, which causes a reaction and generates colour on the pages.

The main drawbacks of these existing techniques are that the colour change is either permanent, or reverses spontaneously, or that they need a specific substrate or paste to be applied onto the canvas or textile, instead of dyeing.

CN106521987 discloses a pH sensitive colour-changing fabric obtained by applying a specific printing paste to a cloth. The use of printing paste denotes the need of a printing process, whereas the present invention consists in the direct dyeing of the cellulosic material, allowing for a more diverse range of applications.

WO2005028524 specifies the possibility of using colour-changing plastics or putties in fabrics via lamination, permeation, dispersion and similar integration methods. Such plastics can be pH susceptible. The present invention concerns molecules applied via dyeing, not integrated plastics or putties, therefore presenting a very different set of characteristics.

GB1121938A discloses a fibre dying method and a fibrous article dyed by said method. The method of producing a fibrous article includes the steps of dying at least part of the fibres with a fast dye and at least part of the fibres with an indicator dye. After dyeing, the fibres may be rinsed in acid or alkaline solution to set the indicator dye on the acid or alkaline side of its shift range. A fibrous article may be produced by dyeing a first predetermined colour on the acid side of its pH shift range and a second predetermined colour on the basic side of its pH shift range, driving the indicator dye to one side of its pH shift range, and dipping a rubber stamp having a predetermined pattern into a solution on the other side of its pH shift range and applying said dipped rubber stamp to said fabric to drive the portion of the fabric contacted thereby to said other side of the pH range.

CN107354745A discloses a method for the preparation of a reusable writing cloth. A special writing cloth is prepared by means of chemically treating a cloth, which can be chemical fabric, cotton or a cloth comprising blended chemical fibres. A writing liquid is used to write on the obtained reusable special writing cloth. The writing is then dried. The handwriting written on said special cloth will fade after washing with water, thus the cloth can be written repeatedly.

GB2339784A discloses a method for the preparation of a plastic film wherein a dyestuff is dispersed. Said dyestuff is capable of undergoing a visible colour change when contacted with a colour-developing chemical substance.

Lien Van der Schueren et al. discloses the application of pH-sensitive dyes on textiles in “Coloration and application of pH-sensitive dyes on textile materials”, Coloration Technology, Wiley, vol. 128, no. 2, 1 Jan. 2012, pages 82-90, XP001597278. A textile-based patch with an integrated pH sensor is described for real-time monitoring of the pH of sweat. In a textile-based patch a pH-sensitive dye was immobilised. The colour-change of the pH-sensitive dye was detected by diffuse reflectance measurements using LED technique. The pH testing of the patch showed a reversible colour change. There are also disclosed natural cellulosic textile fibres treated with conventional dyeing method for incorporating pH-sensitive dyes to achieve halochromic functionality.

CN103590263A discloses a method for preparing a PH colour changing fabric, wherein a bleached cotton fabric is immersed in a dyeing bath. The dyed cotton is then immersed in a pH buffer having a pH range wider than the pH colour shifting of the pH indicator dye.

US 2010/0247371A1 discloses a method of making a reversible colour-changing sanitizer-indicating nonwoven wipe. A solution of a reversible colour-changing ink formulation including an anionic indicator compound is applied into the cloth-like nonwoven fabric, then drying the obtained product to remove organic solvent and to bind the reversible colour-changing ink formulation to the nonwoven fabric. The obtained product is impregnated with a sanitizer composition including a free quaternary ammonium compound. The colour-changing ink formulation reversibly changes between a first colour and a second colour in function of the amount of the free quaternary ammonium compound within the nonwoven wipe.

It is an aim of the invention to provide a system for writing or drawing, or both, on a support, wherein the writing and/or drawing may be removed when requested from the support and does not disappear spontaneously.

Such an aim is reached by means of the present invention.

### SUMMARY OF THE INVENTION

The invention consists in the integration of the prior art in a structure not used before, while also incorporating multiple capabilities of the prior art.

The invention provides a system for writing and/or drawing according to claim 1. In greater detail, the system of the invention comprises a support, e.g. a board, having a surface suitable to receive a writing and/or a drawing, and a device that includes a material suitable to write and/or draw on said support, characterised in that said support comprises a dye, said dye being pH-sensitive, whereby the colour of said dye is modified by a change of the pH on said support; said writing and/or drawing material having a pH configured to provide a change in the colour of said dye on said surface of the support. The board used in the present invention can be a frame, on which a fabric e.g. a canvas is fixed, or a cardboard including or coated/covered with a fabric. Said board can be also notebook, sail, tent, booth, banner and roll up banner.

The pH sensitive material (i.e. chemical molecules) can be used to dye the support, which preferably comprises a plurality of fibers, more preferably cellulosic fibers. Several different dyeing methods can be applied depending on used molecules, such as vat dyeing, reactive dyeing, pigment dyeing, synthetic dyeing, drop-casting, pad-batch dyeing, etcetera. The molecules used for dyeing the support are pH sensitive molecules that can change their colour based on pH, therefore, the coloured support can change its colour depending on the pH of the writing material applied to it. In an embodiment, a paintbrush may apply a writing/drawing material in the form of a basic or acid solution to write/draw anything on the support. For example, the paintbrush may apply a writing/drawing material in the form of a basic solution between 8-13 pH. The writing or drawing on the support appears with different colours (based on the pH sensitive dye and the pH of the “ink”, i.e. the writing/drawing material, that was used); the applied writing/drawing remains visible until it is “cleaned” by applying to it an acidic solution that removes the effect of the previously applied basic “ink”. Accordingly, the applied writing/drawing does not disappear spontaneously. Thus, after finishing the writing or drawing, the support can easily be brought back to its initial colour to provide a clean support that can be used again whenever required to write or draw new writing or drawing.

The invention also provides a method for writing and/or drawing on a support comprising the steps of (i) providing a support dyed with a pH sensitive dye and a material suitable to write and/or draw on said support, i.e. a material having a pH configured to provide a change in the colour of said dye on said surface of the support, and (ii) applying the material suitable to write and/or draw to the support, whereby a writing and/or drawing on said support is obtained. A preferred support to be provided with pH sensible dyes is a fabric, preferably a woven fabric.

### DETAILED DESCRIPTION OF THE INVENTION

As above mentioned, the invention provides a support sensitive to pH and suitable to receive a message, i.e. a writing and/or a drawing, by means of a writing material (that acts as an ink).

In an embodiment, the support, e.g. a board, includes or is coated/covered with, a fabric, for example a fabric comprising cellulosic fibers, similarly to a canvas. According to embodiments, the fabric that covers the board comprises cellulosic fibers or synthetic fibers or blends thereof. The term “cellulosic fibers” indicates fibers comprising cellulose. The fabric comprises natural cellulose fibers, as for example cotton, and/or manufactured cellulose fibers, as for example rayon or viscose. The term “manufactured cellulose fibers” indicates fibers coming from plants that are processed into a pulp and then extruded in the same ways in which synthetic fibers like polyester or nylon are made.

According to embodiments, the fabric may be made from cotton, cotton blends or natural or manufactured cellulosics or blends thereof. Examples of blends are blends of cotton or rayon/viscose with one or more companion material such as natural fibers (e.g. wool, silk, bamboo, banana, etc.), synthetic fibers (e.g. polyamide fibers, acrylic fibers, polyester fibers, polyvinyl alcohol fibers, polyvinyl chloride fibers, polyvinylidene chloride fibers, polyurethane fibers, polyurea fibers, aramid fibers), and cellulose-containing fibers (e.g. rayon/viscose, ramie, hemp, flax/linen, jute, cellulose acetate fibers, lyocell).

According to embodiments, the fabric that covers the board may be a denim fabric. Denim is a sturdy cotton warp-faced textile in which the weft passes under two or more warp threads.

Advantageously, the board includes a fabric, preferably a woven fabric, comprising cellulosic fibers, similarly to canvas. Such fabric is dyed with at least one pH sensitive chemical compound that acts as dyes to provide a coloured support and particularly a treated writable surface of the support. The colour may include transparent, so as to show the original colour of the support writable surface. The molecule(s) used for dyeing canvas is/are pH sensitive, and can change colour based on pH: therefore, the coloured canvas can change its colour depending on the pH. More specifically, the colour of the material can be changed by means of varying the pH of the support through application of acidic or basic substances and aqueous solutions, whereby the pH sensitive molecule(s) changes its/their structure, e.g. by losing or gaining a proton, providing changes in its/their chromophore. Since the water uptake of the cotton is much higher than the synthetics, the reaction time on cotton is faster than on synthetics. Therefore, advantageously, the response time on cellulose-based fabric, is faster than the response time of the pH-sensitive dyes on other materials in case of aqueous application of the writing and/or drawing material. In addition, also the concentration of the dye affects the reaction time.

According to embodiments, the writing and/or drawing system of the invention comprises a support having a surface, said support preferably being or including a board, and a device that includes a writing and/or drawing material suitable to write and/or draw on said support. Advantageously, a fabric may be said support.

According to embodiments, the support can also consist essentially of a fabric, preferably a fabric comprising cellulosic fibers, whereby the support is suitable to be for example a banner, e.g. a sport banner.

In an embodiment, the writing and/or drawing system of the invention further includes at least a second device including a second material having a pH suitable to bring the pH of the areas of said support (that have been treated with the pH changing first writing material) at least to its initial value and to return the initial colour to said dye, whereby the writing applied to the writable surface with the first—writing—material can be removed upon a pH change. The removal of the writing or drawing is in fact obtained by the change of the structure of the dye molecule, in particular of its chromophore, due to a change of pH on the support surface where the writing with the first writing material was done.

As mentioned, the support dyed with the pH sensitive dyes preferably includes cellulosic fibers; preferably said fibers are provided as at least part of a fabric. Other fibers may be used when they are suitable to be dyed with pH-sensitive dyes: for example, cellulosic fibers, such as cotton fibers, can blended to synthetic fibers, such as PET, PP, PE. In an embodiment, the dyes are dispersed or housed within or applied to the fibers of the support.

A suitable support is a canvas, preferably an un-primed canvas. In embodiments, the support is one of a canvas, notepad, billboard and advertising poster.

In an embodiment, the dyes are sensitive to alkaline pH, the pH of the writing material is basic and the pH of said second material suitable to remove pH is less than 7.0, preferably less than 6.0.

The molecules, i.e. the dyes, that are pH sensitive and are suitable for dyeing the supports according to the invention are of various types. Some of these dyes can be used conventionally as pH indicators. The dyes can be divided into three main groups based on their different response upon treatment with acidic and basic writing material:

A) Coloured dyes that can change their colours to two different colours based on pH of the writing material (group A);
B) Coloured dyes that can change their colours to a different colour (group B);
C) Non-coloured (transparent) dyes that can change their colours to a different colour (group C).

Each dye of group A can provide three colours to the support: a first colour, which is the support “original” colour when dyed with a dye of group A, a second colour, which is obtained when an acidic writing material is applied, and a third colour, which is obtained when a basic writing material is applied. It should be noted that, according to the present invention, “acidic writing material” and “basic writing material” or similar refers to a writing material that is more acidic (i.e. has lower pH) or more basic (i.e. has higher pH) with respect to the pH of the operational range of a given dye (the operational range is the range of pH in which a pH sensitive molecule changes its colour). For example, Congo Red has an operational range pH of about 3.5 to 4.5, therefore, referring to Congo Red, an “acidic writing material” has a pH of about 3.5 or lower, and a “basic writing material” has a pH of about 4.5 or higher. The dyes of group A may also allow “multi-coloured” drawings and/or writings; for example, when the acidic writing material is applied to the support dyed with a group A dye in a specific area, and the basic writing material is applied to the same support in a different area, the support will show a total of three different colour simultaneously, namely the colour provided by the acidic writing material, the colour provided by the basic writing material, and the colour of the support dyed with the group A dye. Illustrative dyes of group A are the following: 1-(2-pyridylazo)-2-naphthol (PAN), Alizarin Red S (3,4-Dihydroxy-9,10-dioxo-2-anthracenesulfonic acid sodium salt), Bromocresol green (3′,3″,5′,5″-Tetrabromo-m-cresol sulfonephthalein), Bromocresol purple (5,5′-Dibromo-o-cresolsulfonephthalein), Bromophenol blue (3′,3″-Dibromothymolsulfonephthalein), Indigo Carmine GR (Indigo-5,5′-disulfonic acid disodium salt), Methyl Blue (Aniline blue water soluble) and Thymol Blue (Thymolsulfonphthalein).

1-(2-pyridylazo)-2-naphtol (PAN) provides an orange colour to the support dyed with it. The colour of the support changes, in the areas in which the writing material is applied, to yellow when the writing material is acidic, and to pink when the writing material is basic. Accordingly, a yellow writing or drawing is obtained when an acidic writing material is applied to the support; if a basic writing material is applied in the same areas of the support (i.e. on the yellow writing or drawing), the colour will change from yellow to pink via an intermediate orange colour (which is the “original” support colour when it is dyed with PAN). The same happens (with inverted colours) also when a basic writing material is first applied to the support, and a subsequent acidic writing material is applied in the same areas. The same applies to every dye of group A, e.g. the ones listed below.

Alizarin Red S (3,4-Dihydroxy-9,10-dioxo-2-anthracenesulfonic acid sodium salt) provides a brick red colour to the support dyed with it, e.g. when drop-casted. The colour of the support changes, in the areas in which the writing material is applied, to yellow when the writing material is acidic, and to purple when the writing material is basic.

Bromocresol green (3′,3″,5′,5″-Tetrabromo-m-cresolsulfonephthalein) provides a deep green colour to the support dyed with it. The colour of the support changes, in the areas in which the writing material is applied, to yellow when the writing material is acidic, and to blue when the writing material is basic.

Bromocresol purple (5,5′-Dibromo-o-cresolsulfonephthalein) provides a blue-yellow colour to the support dyed with it. The colour of the support changes, in the areas in which the writing material is applied, to yellow when the writing material is acidic, and to dark blue when the writing material is basic.

Bromophenol blue (3′,3″-Dibromothymolsulfonephthalein) provides a dark-blue colour to the support dyed with it, e.g. when drop casted. The colour of the support changes, in the areas in which the writing material is applied, to yellow when the writing material is acidic, and to purple when the writing material is basic.

Indigo Carmine GR (Indigo-5,5′-disulfonic acid disodium salt) provides a blue colour to the support dyed with it. The colour of the support changes, in the areas in which the writing material is applied, to dark blue when the writing material is acidic, and to yellow when the writing material is basic.

Methyl Blue (Aniline blue water soluble) provides a blue colour to the support dyed with it. The colour of the support changes, in the areas in which the writing material is applied, to light pink when the writing material is basic, and to blue-purple when the writing material is basic.

Thymol Blue (Thymolsulfonphthalein) provides a vivid yellow colour to the support dyed with it. The colour of the support changes, in the areas in which the writing material is applied, to pink when the writing material is acidic and to blue when the writing material is basic.

Table I below summarizes the dyes of group A discussed above.

TABLE I

| | Acid pH colour - | Original | Basic pH colour - |
|---|---|---|---|
| | provided when | support | provided when |
| | acidic writing | colour | basic writing |
| Dye | matter is applied | after dying | matter is applied |
| PAN | Yellow | Orange | Pink |
| Alizarin Red S | Yellow | Brick red | Purple |
| Bromocresol green | Yellow | Green | Blue |
| Bromocresol purple | Yellow | Blue-yellow | Dark blue |
| Bromophenol blue | Yellow | Dark-blue | Purple |
| Indigo Carmine GR | Dark blue | Blue | Yellow |
| Methyl Blue | Blue-purple | Blue | Light pink |
| Thymol Blue | Pink | Yellow | Blue |

Each dye of group B can provide two colours to the support: a first colour, which is the support “original” colour when dyed with a dye of group B, and a second colour, which is obtained when an acidic or basic writing material is applied. Illustrative dyes of group B are the following: Benzopurpurine 4B, Congo Red, Eriochrome Black T, Iodine, Methyl Orange (4-[4-(Dimethylamino)phenylazo]benzenesulfonic acid sodium salt) and Xylenol Orange tetrasodium salt (3,3′-Bis[N,N-bis(carboxymethyl)aminomethyl]-o-cresolsulfonephthalein tetrasodium salt).

Benzopurpurine 4B provides an orange-red colour to the support dyed with it. The colour of the support changes, in the areas in which the writing material is applied, to dark blue when the writing material is acidic, and to the original orange-red when the writing material is basic. Accordingly, a basic writing material can be used to erase the dark blue colour of the acidic writing material, whereby the colour of the support returns to orange-red. This applies mutatis mutandis with the other dyes of group B.

Congo Red provides a vivid red colour to the support dyed with it. The colour of the support changes, in the areas in which the writing material is applied, to dark blue when the writing material is acidic, and to the original vivid red when the writing material is basic.

Eriochrome Black T provides a purple colour to the support. The colour of the support changes, in the areas in which the writing material is applied, to pink-red when the writing material is basic, and then to the original purple when the writing material is acidic.

Iodine provides a camel colour to the support. The colour of the support changes, in the areas in which the writing material is applied, to white when the writing material is basic, and to the original camel colour when the writing material is acidic.

Methyl Orange (4-[4-(Dimethylamino)phenylazo]benzenesulfonic acid sodium salt) provides a yellow colour to the support. The colour of the support changes, in the areas in which the writing material is applied, to pink when the writing material is acidic, and to the original yellow when the writing material is basic.

Xylenol Orange tetrasodium salt (3,3′-Bis[N,N-bis(carboxymethyl)aminomethyl]-o-cresolsulfonephthalein tetrasodium salt) provides a purple colour to the support. The colour of the support changes, in the areas in which the writing material is applied, to yellow when the writing material is acidic, and to the original purple when the writing material is basic.

Table II below summarizes the dyes of group B discussed above.

TABLE II

| | Acid pH colour - | Original | Basic pH colour - |
|---|---|---|---|
| | provided when | support | provided when |
| | acidic writing | colour | basic writing |
| Dye | matter is applied | after dyeing | matter is applied |
| Benzopurpurine 4B | Dark blue | Orange-red | Orange-red |
| Congo Red | Dark blue | Red | Red |
| Eriochrome Black T | Purple | Purple | Pink-red |
| Iodine | Camel | Camel | White |
| Methyl Orange | Pink | Yellow | Yellow |
| Xylenol Orange | Yellow | Purple | Purple |
| tetrasodium salt | | | |

Supports dyed with a dye of group C maintain their colour, as dyes of group C are substantially transparent and do not provide any colour to supports dyed with them. Accordingly, the support can change its colour when an acidic or basic writing material is applied to it. Illustrative dyes of group C are the following: Phenolphthalein (3,3-Bis(4-hydroxyphenyl)-1(3H)-isobenzofuranone) and Thymolphthalein (5′,5″-Diisopropyl-2′,2″-dimethylphenolphthalein).

Phenolphthalein (3,3-Bis(4-hydroxyphenyl)-1(3H)-isobenzofuranone) provides a pink colour to the support dyed with it in the areas in which a basic writing material is applied. The writings or drawings are erased when an acidic writing material is applied.

Thymolphthalein (5′,5″-Diisopropyl-2′,2″-dimethylphenolphthalein) provides a blue colour to the support dyed with it in the areas in which a basic writing material is applied. The writings or drawings are erased when an acidic writing material is applied.

The support can be dyed with pH sensitive material, i.e. a dye, according to conventional dyeing methods. For example, the dye is dissolved in a proper solvent, such as water, ethanol, isopropyl alcohol, their mixtures etc., and is applied to the support using pad-batch dyeing machine. The support is then dried at temperatures ranging from room temperature to 100° C., preferably from 30° C. to 60° C., for 1 min to 120 min. Advantageously, the higher is the temperature of the drying step, the stronger is the drying step.

According to embodiments, after the drying step, the support is treated to fix the dye on the support at 110° C. to 120° C. for 30 sec to 5 min, preferably for 45-60 seconds. The fixing step includes a high temperature treatment. According to an example, the dye is dissolved in a proper solvent, such as water, ethanol, isopropyl alcohol, etc., and is applied to the support using a Pasteur pipette. The support is then dried at room temperature for 120 minutes and fixed at 100° C. for 1 min.

Suitable writing materials are known in the art. In general, writing materials can be aqueous basic or acid solutions. For example, acid writing materials can be solutions of inorganic acids such as HCl, HNO₃, H₃PO₄, H₂SO₄, H₃BO₃, HF, HBr, HClO₄, and HI, organic acids such as carboxylic acids (e.g. acetic acid, propionic acid, butanoic acid, etc.), and mixtures thereof. The acid writing materials can also be common solutions/fluids available to the end users, such as vinegar. Accordingly, the basic writing materials can be, for example, solutions of inorganic bases such as KOH, NaOH, Ba(OH)₂, CaCO₃, and Mg(OH)₂, organic bases such as amines, and mixtures thereof. The basic writing materials can also be common solutions/fluids available to the end users, such as a baking soda (NaHCO₃) solution.

The writing material can be applied by means of one or more devices that are able to apply fluids to a solid support, e.g. paintbrushes, and felt tip pens, or simply by dropping it onto the support.

Another subject-matter of the invention is a writing and/or drawing support having a surface, characterised in that said support comprises a dye, said dye being pH-sensitive, whereby the colour of said dye is modified by a change of the pH on said support. The change of the pH can be carried out for example by means of a writing and/or drawing material. The support according to the present subject-matter is the same as the one disclosed above for the system of the invention in any of its embodiment.

A further subject-matter of the invention is a method for writing and/or drawing on a support comprising the following steps:

a) providing a support having a surface and a material suitable to write and/or draw on said support, applying a dye to said support;
b) applying the writing/and/or drawing material to the support, whereby a writing and/or drawing on the support is obtained;
characterized in that the support comprises a dye, the dye being pH-sensitive, whereby the colour of said dye is modified by a change of the pH on said support; the writing and/or drawing material having a pH configured to provide a change in the colour of the dye on the surface of the support.

According to a further embodiment, the method of the present invention comprises a further step, i.e. step c):

applying a second material having a pH suitable to bring the pH of the areas of the support at least to its initial value and to return the initial colour to said dye.

According to embodiments, the method for writing and/or drawing on a support may comprise before step b) the additional steps of:

a′) drying the support; and
a″) fixing the support.

According to embodiments, in step a′) the support is dried at temperatures ranging from room temperature to 100° C., preferably from 30° C. to 60° C., for 1 min to 120 min. According to embodiments, in step a″) the support is fixed at 110° C. to 120° C. for 30 sec to 5 min, preferably for 45-60 seconds. According to a preferred embodiment of the invention, the method for writing and/or drawing on a support comprises the following steps:

a) providing a support having a surface and a writing and/or drawing material suitable to write and/or draw on said support, applying a dye to said support;
a′) drying said support;
a″) fixing said dye on said support.
b) applying said writing and/or drawing material to said support, whereby a writing and/or drawing on said support is obtained;
c) applying a further material having a pH suitable to bring the pH of the areas of the support at least to its initial value and to return the initial colour to said dye. The supports, dyes and writing materials suitable for the method of the invention are the same as the ones disclosed for the system of the invention in any of its embodiments. Accordingly, the method of the invention can be carried out with the system of the invention.

### DESCRIPTION OF THE FIGURE

FIG. 1 is a scheme representing embodiments of the method of the invention.

### DETAILED DESCRIPTION OF THE FIGURE AND EXPERIMENTAL SECTION

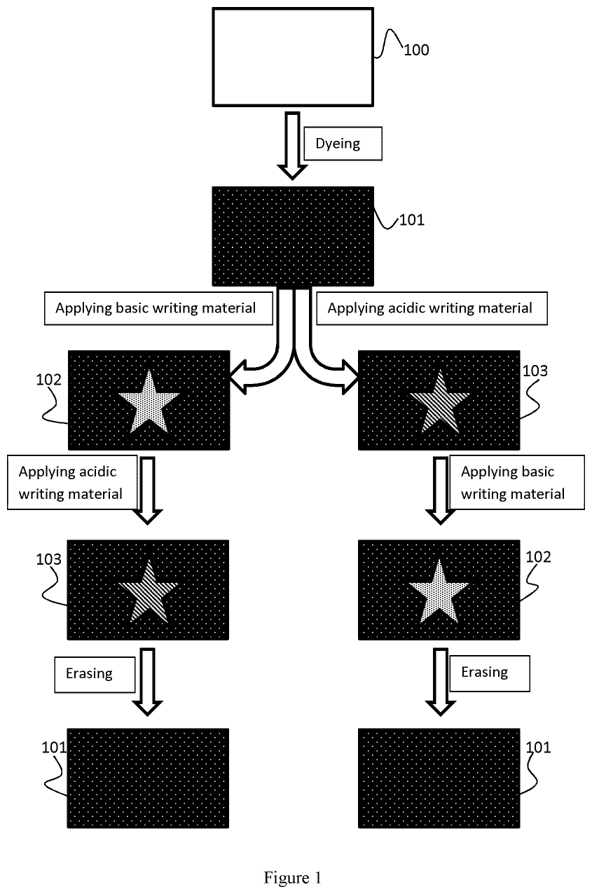

The invention will be further illustrated by means of FIG. 1 and of examples that are provided for illustrative purposes only and do not aim to limit the scope of the invention.

### Example 1—Preparation of the Support by Drop-Casting

A pH sensitive board including cotton fabric is prepared as follows. A 5 g/l solution of Alizarin Red S is prepared by dissolving 5 g of Alizarin Red S (3,4-Dihydroxy-9,10-dioxo-2-anthracenesulfonic acid sodium salt) in 1 l of distilled water in volumetric flask and by stirring for 5 minutes. The cotton fabric 100 is dyed by drop-casting using the Alizarin Red S solution. The board is dried at 100° C. for 1 min and then dye is fixed at 110° C. for 1 min. The cotton fabric 101 so-obtained has a brick red colour.

### Example 2—Preparation of the Support by Pad-Batch Dyeing

A pH sensitive fabric is prepared as follows. A 5 g/l solution of Alizarin Red S is prepared as for Example 1. The fabric 100 is dyed with the Alizarin Red S solution using a pad-batch dyeing machine. The pad-batch dyeing is carried out with a pressure of the cylinders of 2 bar and a speed of 2 m/min. The fabric is dried at 100° C. for 1 min and then is fixed at 110° C. for 1 min. The fabric 101 so-obtained has a brick red colour.

### Example 3—Writing and/or Drawing Tests

A solution of 1.0 M sodium hydroxide prepared by dilution of 47° Be NaOH with deionized water is used as basic writing material for the present test. A solution of 1.0 M hydrochloric acid prepared by dilution of 37% concentrated HCl solution with deionized water is used as acidic writing material for the present test. According to the embodiment on the right branch of the scheme of FIG. 1, drops of HCl solution is applied to the brick-red coloured fabric 101 obtained as for Example 1 or Example 2. The areas of the fabric 101 where the HCl solution is applied change colour from brick red to yellow, and a fabric 103 having yellow areas (i.e. yellow writings/drawings) is obtained. The application of the writing material can also be made for example by means of a paintbrush. Afterwards, drops of the NaOH solution are applied to the yellow-coloured areas of the fabric 103, and the colours of these areas change from yellow to purple, thus obtaining a fabric 102 having purple areas (i.e. purple writings/drawings). In order to erase the purple coloured areas and to obtain the original fabric 101, the pH of the purple coloured areas of fabric 102 has to be brought to the operational range pH of the dye, which is about pH 4.6-6.0 for Alizarin Red S; accordingly, to return to the original red-brick colour, the pH has to be adjusted to about 5-5.5, which can be made by preparing a writing material, i.e. an aqueous solution, having suitable pH and by applying it to the purple coloured areas. According to the embodiment on the left branch of the scheme of FIG. 1, the same test as above is also carried out by applying first the NaOH solution to the dyed fabric 101 obtained as for Example 1 or Example 2, providing a fabric 102 having purple coloured areas. Afterwards, the HCl solution is applied to the purple areas of fabric 102, providing a fabric 103 having yellow coloured areas.

These yellow coloured areas can be returned to the original red-brick colour by using a solution having an appropriate pH.

1) A writing and/or drawing system comprising a support having a surface and a device that includes a writing and/or drawing material suitable to write and/or draw on said support, characterised in that said support comprises a dye, said dye being pH-sensitive, whereby the colour of said dye is modified by a change of the pH on said support; said writing and/or drawing material having a pH configured to provide a change in the colour of said dye on said surface of the support.

2) The writing system according to claim 1, further including at least a second device including a further writing and/or drawing material having a pH suitable to bring the pH of the areas of said support at least to its initial value and to return the initial colour to said dye, whereby the applied writing is removed.

3) The writing system according to claim 1 or 2, wherein said support includes a fabric, preferably a woven fabric, and said dye is applied to said fabric.

4) The writing system according to claim 3, wherein said fabric includes cellulosic fibers.

5) The writing system according to any previous claim, wherein said support is one of a canvas, notepad, billboard and publicity poster.

6) The writing system according to claim 5, wherein said support is a canvas, preferably an un-primed canvas.

7) The writing system according to any previous claim, wherein said dye is selected from: 1-(2-pyridylazo)-2-naphtol (PAN); Alizarin Red S (3,4-Dihydroxy-9,10-dioxo-2-anthracenesulfonic acid sodium salt); Bromocresol green (3′,3″,5′,5″-Tetrabromo-m-cresolsulfonephthalein); Bromocresol purple (5,5′-Dibromo-o-cresolsulfonephthalein); Bromophenol blue (3′,3″-Dibromothymolsulfonephthalein); Indigo Carmine GR (Indigo-5,5′-disulfonic acid disodium salt); Methyl Blue (Aniline blue water soluble); Thymol Blue (Thymolsulfonphthalein); and mixtures thereof.

8) The writing system according to any previous claims 1 to 6, wherein said dye is selected from: Benzopurpurine 4; Congo Red; Eriochrome Black T; Iodine; Methyl Orange (4-[4-(Dimethylamino)phenylazo]benzenesulfonic acid sodium salt); Xylenol Orange tetrasodium salt (3,3′-Bis[N,N-bis(carboxymethyl)aminomethyl]-o-cresol sulfonephthalein tetrasodium salt); and mixtures thereof.

9) The writing system according to any previous claims 1 to 6, wherein said dye is selected from: Phenolphthalein (3,3-Bis(4-hydroxyphenyl)-1(3H)-isobenzofuranone); Thymolphthalein (5′,5″-Diisopropyl-2′,2″-dimethylphenolphthalein) and mixtures thereof.

10) The writing system according to any previous claims 1 to 9, wherein the writing material is an aqueous basic solution or an aqueous acid solution.

11) A writing and/or drawing support having a surface, characterised in that said support comprises a dye, said dye being pH-sensitive, whereby the colour of said dye is modified by a change of the pH on said support.

12) The writing support of claim 11, wherein said support is as disclosed in any one of claims 3 to 6.

13) A method for writing and/or drawing on a support comprising the following steps:
a) providing a support having a surface and a writing and/or drawing material suitable to write and/or draw on said support, applying a dye to said support;
b) applying said writing and/or drawing material to said support, whereby a writing and/or drawing on said support is obtained;
characterized in that the support comprises a dye, said dye being pH-sensitive, whereby the colour of said dye is modified by a change of the pH on said support; said writing and/or drawing material having a pH configured to provide a change in the colour of said dye on said surface of the support.

14) The method of claim 13, wherein step c) is further comprised:
c) applying a further writing and/or drawing material having a pH suitable to bring the pH of the areas of said support at least to its initial value and to return the initial colour to said dye.

15) The method of claim 13 or 14, further comprising before step b) the additional steps of:
a′) drying the support; and
a″) fixing the dye on said support.

16) The method of any one of claims 13 to 15, wherein said support includes a fabric, preferably a woven fabric, and said dye is applied to said fabric fibers.

17) The method of any one of claims 13 to 16, wherein said support is one of canvas, notepad, billboard and publicity poster.

18) The method of any one of claims 13 to 17, wherein said dye is selected from the dyes of claim 7, or of claim 8, or of claim 9.
